(19) United States
(12) Patent Application Publication
(10) Pub. No.: US 2017/0323380 A1
(43) Pub. Date: Nov. 9, 2017

(54) METHODS AND SYSTEMS FOR IDENTIFYING COMPETITORS USING CONTENT ITEMS INCLUDING CONTENT EXTENSIONS

(71) Applicant: Google Inc., Mountain View, CA (US)

(72) Inventors: Christopher Brian Alberti, Mountain View, CA (US); David Vespe, Mountain View, CA (US); Jonathan Ezra Feldman, Mountain View, CA (US)

(73) Assignee: Google Inc., Mountain View, CA (US)

(21) Appl. No.: 14/134,441

(22) Filed: Dec. 19, 2013

(51) Int. Cl. G06Q 30/08

(52) U.S. Cl. CPC G06Q 30/08

(57) ABSTRACT

Systems and methods for identifying competitors using content extensions in content items in content items associated with their content placement campaigns are described. A processor identifies one or more competing entities from auctions in which the first entity places a bid. The competing entities are associated with content items having a first type of content extension that received impressions in at least one identified auction. The processor computes an overlap rate based on a number of auctions in which both a content item having the first type of content extension of the identified competing entity and a content item of the first entity received impressions and a number of auctions in which a content item having the first type of content extension of the identified competing entity received an impression and the first entity competed. The processor ranks the competing entities based on the computed overlap rate.

### BACKGROUND

Text-based third-party content items are often displayed with enhanced features or content extensions. These content extensions can provide additional functionality to a third-party content item, which can increase the conversion rate for the third-party content item. Examples of content extensions can include sitelinks, which are links pointing to specific web pages associated with the content item; click to call, which is a link to place a call to the entity associated with the content item; ratings, which indicates an average user rating associated with the entity associated with the content item; and social aggregate annotation, which indicates a number of social networking users who have expressly approved the entity, amongst others. However, third-party content providers have little visibility into information regarding the use of such content extensions, in particular, by entities competing with the third-party content providers.

### SUMMARY

At least one aspect is directed to a method for identifying competitors using content items including content extensions is described. A data processing system identifies from auction log data, a plurality of auctions in which a first entity places a bid for a third-party content item corresponding to a content placement campaign of the first entity. The data processing system identifies one or more competing entities from the identified auctions in which the first entity places a bid. Each of the competing entities is associated with a content placement campaign that includes at least one content item having a first type of content extension that was selected for display in one or more of the identified plurality of auctions. The data processing system determines, for each identified competing entity, a first number of auctions in which a content item having the first type of content extension of the identified competing entity was selected for display and a third-party content item of the first entity also was selected for display. The data processing system also determines, for each identified competing entity, a second number of auctions in which a content item having the first type of content extension of the identified competing entity was selected for display and the first entity placed a bid. The data processing system then computes, for each competing entity, an overlap rate for the first type of content extension based on the ratio of the first number associated with a particular competing entity to the second number associated with the particular competing entity. The data processing system then ranks one or more of the competing entities based on the calculated overlap rate for the first type of content extension.

In some implementations, the content extension includes one of a click to call extension, a sitelinks extension, a rating extension, a geographical extension or a social aggregate annotation extension. In some implementations, the data processing system identifies one or more competing entities by identifying a website domain associated with the competing entities.

In some implementations, the data processing system can provide a predetermined number of competing entities in order of their rank for display. In some implementations, the data processing system can provide competing entities having an overlap rate greater than a predetermined threshold for display.

In some implementations the data processing system can identify, from the identified auctions in which the first entity places a bid, one or more competing entities associated with a content placement campaign that includes at least one content item having a second type of content extension that was selected for display in one or more of the identified plurality of auctions. The data processing system can then determine, for each identified competing entity, a third number of auctions in which a content item having the second type of content extension of the identified competing entity was selected for display and a third-party content item of the first entity was selected for display. The data processing system can determine, for each identified competing entity, a fourth number of auctions in which a content item having the second type of content extension of the identified competing entity was selected for display and the first entity placed a bid. The data processing system then computes, for each competing entity, an overlap rate for the second type of content extension based on the ratio of the third number associated with a particular competing entity to the fourth number associated with the particular competing entity. The data processing system then ranks one or more of the competing entities based on the calculated overlap rate for the second type of content extension.

At least one aspect is directed to a computer implemented system for identifying competitors using content items including content extensions. The system includes a data processing system that has an auction log analysis module and a competitor identification module. The data processing system can include a memory storing processor-executable instructions and a processor configured to execute the processor executable instructions. In some implementations, the processor can identify from auction log data, a plurality of auctions in which a first entity places a bid for a third-party content item corresponding to a content placement campaign of the first entity. The data processing system identifies one or more competing entities from the identified auctions in which the first entity places a bid. Each of the competing entities is associated with a content placement campaign that includes at least one content item having a first type of content extension that was selected for display in one or more of the identified plurality of auctions. The processor can determine, for each identified competing entity, a first number of auctions in which a content item having the first type of content extension of the identified competing entity was selected for display and a third-party content item of the first entity was selected for display. The processor can also determine, for each identified competing entity, a second number of auctions in which a content item having the first type of content extension of the identified competing entity was selected for display and the first entity placed a bid. The processor can compute, for each competing entity, an overlap rate for the first type of content extension based on the ratio of the first number associated with a particular competing entity to the second number associated with the particular competing entity. The processor can then rank one or more of the competing entities based on the calculated overlap rate for the first type of content extension.

In some implementations, the content extension includes one of a click to call extension, a sitelinks extension, a rating extension, a geographical extension or a social aggregate annotation extension. In some implementations, the processor can identify one or more competing entities by identifying a website domain associated with the competing entities.

In some implementations, the processor can provide a predetermined number of competing entities in order of their rank for display. In some implementations, the processor can provide competing entities having an overlap rate greater than a predetermined threshold for display.

In some implementations, the processor can identify, from the identified auctions in which the first entity places a bid, one or more competing entities associated with a content placement campaign that includes at least one content item having a second type of content extension that was selected for display in one or more of the identified plurality of auctions. The processor can then determine, for each identified competing entity, a third number of auctions in which a content item having the second type of content extension of the identified competing entity was selected for display and a third-party content item of the first entity was selected for display. The processor can determine, for each identified competing entity, a fourth number of auctions in which a content item having the second type of content extension of the identified competing entity was selected for display and the first entity placed a bid. The processor then computes, for each competing entity, an overlap rate for the second type of content extension based on the ratio of the third number associated with a particular competing entity to the fourth number associated with the particular competing entity. The processor then ranks one or more of the competing entities based on the calculated overlap rate for the second type of content extension.

At least one aspect is directed to a method identifying competitors using content items including content extensions. A data processing system identifies from auction log data, a plurality of auctions in which a first entity places a bid for a third-party content item corresponding to a content placement campaign of the first entity. The data processing system identifies, from the identified auctions in which the first entity places a bid, one or more competing entities. Each of the competing entities is associated with a content placement campaign that includes at least one content item having a first type of content extension that was selected for display in one or more of the identified plurality of auctions. The data processing system computes, for each identified competing entity, an overlap rate representing how often a competitor's content item was selected for display while the first entity's content item also was selected for display. The data processing system also computes, for each of the identified competing entities, a content extension usage rate representing how often a competitor's content item having a content extension was selected for display when displaying a content item. The data processing system then computes a content extension usage overlap rate for each of the identified competing entities based on the computed overlap rate and content extension usage rate corresponding to the particular competing entity for which the content extension usage overlap rate is computed. The data processing system then ranks the competing entities based on their computed content extension usage overlap rates.

In some implementations, the content extension includes one of a click to call extension, a sitelinks extension, a rating extension, a geographical extension or a social aggregate annotation extension. In some implementations, identifying one or more competing entities includes identifying a website domain associated with the competing entities. In some implementations, the data processing system can provide the competing entities having a content extension usage overlap rate greater than a predetermined threshold for display.

In some implementations, the data processing system determines, for each of the identified competing entities, a first number of impressions received by one or more content items of the competing entity. The data processing system also determines, for each of the identified competing entities, a second number of impressions received by one or more content items of the competing entity in auctions in which one or more content items of the first entity also were selected for display. In some implementations, the data processing system 110 computes, for each identified competing entity, an overlap rate by determining a ratio of the second number of impressions received by one or more content items of the competing entity in auctions in which one or more content items of the first entity also were selected for display to the first number of impressions received by one or more content items of the competing entity.

In some implementations, the data processing system can determine the second number of impressions by identifying a number of auctions in which the competing entity showed above the first entity and identifying a number of auctions in which the competing entity showed below the first entity. The data processing system can then add the number of auctions in which the competing entity showed above the first entity and the number of auctions in which the competing entity showed below the first entity to determine the second number of impressions.

In some implementations, computing the content extension usage rate of a competing entity includes determining a ratio of a number of impressions received by content-extension content items of the competing entity to a number of impressions received by the competing entity in auctions where the first entity was competing. Each of the content-extension content items includes a content item having a particular type of content extension.

In some implementations, the data processing system can compute the content extension usage overlap rate for each of the identified competing entities by computing a product of the computed overlap rate and the computed content extension usage rate corresponding to the particular competing entity for which the content extension usage overlap rate is computed.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one implementation of an environment for identifying competitors using content items including content extensions, according to an illustrative implementation;

FIG. 2 is a diagram depicting content items including content extensions;

FIG. 3 is a screenshot of a user interface depicting a number of competitors that use content extensions; and

FIG. 4 is a flow diagram depicting one implementation of the steps taken to identify and rank competitors using content items including content extensions;

FIG. 5 is a flow diagram depicting one implementation of the steps taken to identify and rank competitors using content items including content extensions; and

FIG. 6 is a block diagram illustrating an implementation of a general architecture for a computer system that may be employed to implement various elements of the systems and methods described and illustrated herein.

### DETAILED DESCRIPTION

Following below are more detailed descriptions of various concepts related to, and implementations of, methods, apparatuses, and systems for identifying competitors using content items including content extensions. The various concepts introduced above and discussed in greater detail below may be implemented in any of numerous ways, as the described concepts are not limited to any particular manner of implementation. Examples of specific implementations and applications are provided primarily for illustrative purposes.

Third-party content providers can provide third-party content items for display on web pages by participating in auctions. The third-party content providers can manage bids, view performance and create content placement campaigns via a content placement campaign management tool. Recently, some third-party content items are being displayed with enhanced features or content extensions. Examples of content extensions can include sitelinks, which are links pointing to specific web pages associated with the content item; click to call, which is a link to place a call to the entity associated with the content item; ratings, which indicates a rating associated with the entity associated with the content item; and social aggregate annotation, which indicates a number of social networking users who have expressly approved the entity, amongst others. These content extensions have been shown to improve click-through rates of third-party content items. Moreover, third-party content items that use or include content extensions are more likely to be selected for display or be ranked higher than counterpart third-party content items that do not include content extensions. As such, third-party content providers have expressed a desire to gain more information regarding the use of such content extensions.

Currently, there is no efficient way for a third-party content provider to know, for a particular content placement campaign, which competitors are using which types of content extensions. The present disclosure aims to address this by describing methods and systems for identifying competitors that are using content extensions in content items.

According to one aspect, a method for identifying competitors using content items including content extensions is described. A data processing system identifies from auction log data, a plurality of auctions in which a first entity places a bid for a third-party content item corresponding to a content placement campaign of the first entity. The data processing system identifies one or more competing entities from the identified auctions in which the first entity places a bid. Each of the competing entities is associated with a content placement campaign that includes at least one content item having a first type of content extension that was selected for display in one or more of the identified plurality of auctions. The data processing system determines, for each identified competing entity, a first number of auctions in which a content item having the first type of content extension of the identified competing entity was selected for display and a third-party content item of the first entity was selected for display. The data processing system also determines, for each identified competing entity, a second number of auctions in which a content item having the first type of content extension of the identified competing entity was selected for display and the first entity placed a bid. The data processing system then computes, for each competing entity, an overlap rate for the first type of content extension based on the ratio of the first number associated with a particular competing entity to the second number associated with the particular competing entity. The data processing system then ranks one or more of the competing entities based on the calculated overlap rate for the first type of content extension.

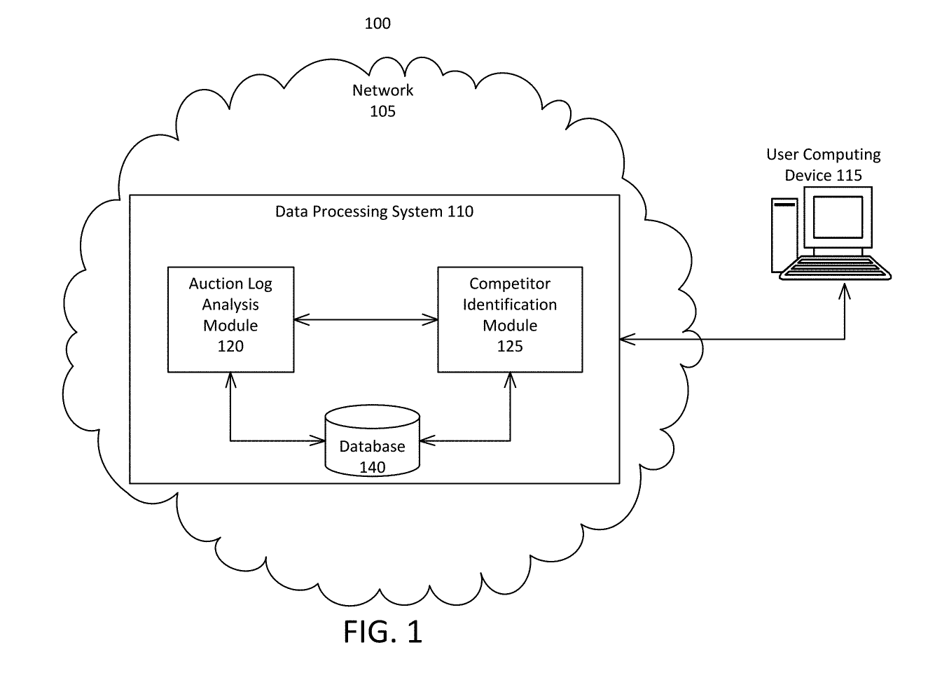

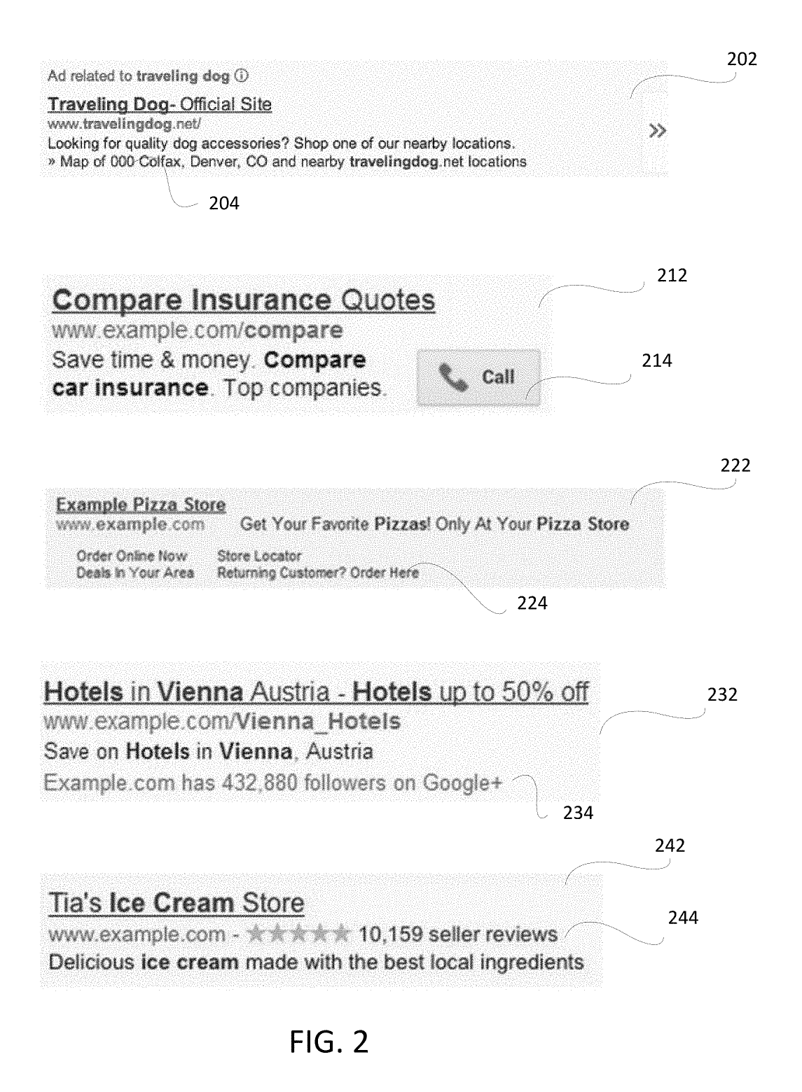

FIG. 1 is a block diagram depicting one implementation of an environment for identifying competitors using content items including content extensions. In particular, FIG. 1 illustrates a system 100 for identifying competitors having one or more content placement campaigns that include content items using content extensions. In particular, the system can be configured to identify competitors associated with content placement campaigns for serving third-party content items having content extensions. Third-party content items are items that can be provided for display on a web page alongside primary content. Examples of third-party content items can include advertisements. Content extensions are features included in third-party content items that provide additional functionality. These content extensions can include sitelinks, which are links, which when clicked, redirect a user to a specific web page corresponding to the clicked link. Other examples of content extensions can include click to call, which provides an icon, which when clicked, establishes a phone call between the user and the phone number associated with the icon, such as the third-party content provider providing the third-party content item. Other examples of content extensions include a rating extension, a geographical extension or a social aggregate annotation extension. Additional examples of content extensions are described with respect to FIG. 2.

The system 100 includes at least one data processing system 110. The data processing system 110 can include at least one processor and a memory, i.e., a processing circuit. The memory stores processor-executable instructions that, when executed by processor, cause the processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language such as, but not limited to, C, C++, C#, Java, JavaScript, Perl, Python and Visual Basic. The data processing system can include one or more computing devices or servers that can perform various functions. In some implementations, the data processing system can include an advertising auction system configured to host auctions. In some implementations, the data processing system does not include the advertising auction system but is configured to communicate with the advertising auction system via the network 105. In some implementations, the data processing system 110 can include a third-party content item generation system configured to generate third-party content items that include content extensions. In some implementations, the data processing system 110 does not include the third-party content item generation system but is configured to communicate with the third-party content item generation system via the network 105. The data processing system 110 can include one or more processors or other logic devices such as a computing device having a processor to communicate via a network 105 with at least one user computing device 115. In some implementations, the user computing device 115 and the data processing system 110 can communicate with one another via the network 105.

The network 105 may be any form of computer network that relays information between the user computing device 115, data processing system 110, and one or more content sources, for example, web servers, advertising servers, amongst others. For example, the network 105 may include the Internet and/or other types of data networks, such as a local area network (LAN), a wide area network (WAN), a cellular network, satellite network, or other types of data networks. The network 105 may also include any number of computing devices (e.g., computer, servers, routers, network switches, etc.) that are configured to receive and/or transmit data within network 105. The network 105 may further include any number of hardwired and/or wireless connections. For example, the user computing device 115 may communicate wirelessly (e.g., via WiFi, cellular, radio, etc.) with a transceiver that is hardwired (e.g., via a fiber optic cable, a CAT5 cable, etc.) to other computing devices in network 105.

The user computing device 115 may be any number of different user electronic devices, for example, a laptop computer, a desktop computer, a tablet computer, a smartphone, a digital video recorder, a set-top box for a television, a video game console, or any other computing device configured to communicate via the network 105. The user computing device 115 can include a processor and a memory, i.e., a processing circuit. The memory stores machine instructions that, when executed by processor, cause processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language such as, but not limited to, C, C++, C#, Java, JavaScript, Perl, Python and Visual Basic.

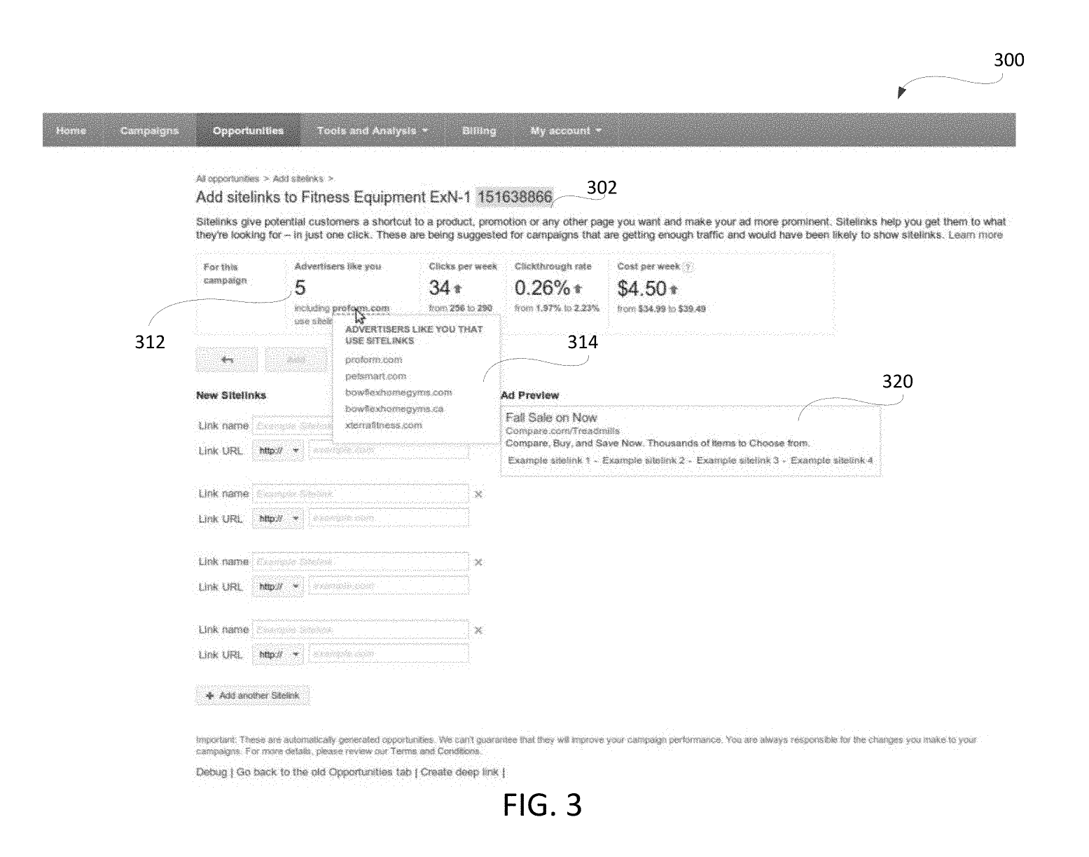

The user computing device 115 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of the user computing device 115 (e.g., a built-in display, microphone, etc.) or external to the housing of the user computing device 115 (e.g., a monitor connected to the user computing device 115, a speaker connected to the user computing device 115, etc.), according to various implementations. For example, the user computing device 115 may include an electronic display, which visually displays web pages using webpage data received from one or more content sources and/or from the data processing system 110 via the network 105. In some implementations, a content placement campaign manager or advertiser can communicate with the data processing system 110 via the user computing device 115. In some implementations, the advertiser can communicate with the data processing system 110 via a user interface displayed on the user interface devices of the user computing device 115. Aspects of the user interface are described below with respect to FIG. 3.

The data processing system 110 can include at least one server. In some implementations, the data processing system 110 includes an auction log analysis module 120 and a competitor identification module 125. The data processing system can also include one or more content repositories or databases 140.

The auction log analysis module 120 can be designed, constructed or configured to access auction log data. The auction log data corresponds to data generated from auctions. The auctions can be auctions for selecting content items for display. In some implementations, the content items can be third-party content items or advertisements, which can be displayed in third-party content slots positioned on one or more resources or documents, such as web pages. In some implementations, an advertising auction system can be configured to host auctions. In some implementations, the advertising auction system can be a part of the data processing system. In some implementations, the advertising auction system can log auction related data in an auction log. In some implementations, the auction log can include entries for each auction conducted or hosted by the advertising auction system. In some implementations, each entry can include information identifying all of the bids received in the auction, campaign identifiers associated each of the bids, the content items, the content extensions associated with the items, the position associated with each of the winning content items, the position associated with each of the losing content items, the website or visible domain with which the content item is associated with each of the content items for which bids were received, amongst others.

In some implementations, the data processing system 110 does not include the advertising auction system but is configured to communicate with the advertising auction system via the network 105. In some implementations, an auction a identify from auction log data, a plurality of auctions in which a first entity places a bid for a third-party content item corresponding to a content placement campaign of the first entity.

In some implementations, the auction log analysis module 120 can be configured to identify, from auction log data, a plurality of auctions in which a first entity places a bid for a third-party content item corresponding to a content placement campaign of the first entity. In some implementations, the auction log analysis module 120 can perform a lookup of the auction log database and identify the auctions in which an entity placed a bid for a third-party content item.

The auction log analysis module 120 can be configured to identify one or more competing entities from the identified auctions in which the first entity places a bid. In some implementations, each of the competing entities is associated with a content placement campaign that includes at least one content item having a first type of content extension that was selected for display in one or more of the identified plurality of auctions. In some implementations, the auction log analysis module 120 can be configured to identify content items having content extensions that received impressions in auctions in which the first entity placed a bid. The auction log analysis module 120 can then determine the entities associated with the identified content items having content extensions and identify such entities as competing entities that are competing with the first entity. In some implementations, a content item that has been selected for display can correspond to a content item that receives an impression.

The auction log analysis module 120 can be configured to determine, for each identified competing entity, a first number of auctions in which a content item having the first type of content extension of the identified competing entity was selected for display and a third-party content item of the first entity also was selected for display. In some implementations, the auction log analysis module 120 can identify, from the auction log data, auctions in which a third-party content item of the first entity was selected for display. From the identified auctions in which a third-party content item of the first entity was selected for display, the auction log analysis module 120 can determine a number of auctions in which a content item of an identified competitor having a first type of content extension also was selected for display.

The auction log analysis module 120 can be configured to determine, for each identified competing entity, a second number of auctions in which a content item having the first type of content extension of the identified competing entity was selected for display and the first entity placed a bid. In some implementations, the auction log analysis module 120 can identify, from the auction log data, auctions in which a third-party content item of the first entity placed a bid. From the identified auctions in which a third-party content item of the first entity placed a bid, the auction log analysis module 120 can determine a number of auctions in which a content item of an identified competitor having a first type of content extension also was selected for display.

The competitor identification module 125 of the data processing system 110 can be configured to compute, for each competing entity, an overlap rate for the first type of content extension based on the ratio of the first number associated with a particular competing entity to the second number associated with the particular competing entity. The competitor identification module 125 can be configured to compute an overlap rate that is specific to a particular type of content extension and that is specific to a competing entity. As such, the total number of overlap rates the competitor identification module may compute can be a function of the total number of different content extensions and the total number of competing entities competing with the first entity.

For any given type of content extension, the competitor identification module 125 can further be configured to rank one or more of the competing entities based on the computed overlap rate for the given type of content extension. In some implementations, a subset of the competing entities are ranked. For example, in some implementations, the competitor identification module 125 may first identify competing entities that have an overlap rate that exceeds a predetermined threshold, for example, 5%. The competitor identification module 125 may then rank the competing entities that have an overlap rate that exceeds the predetermined threshold in accordance with their overlap rates. The competitor identification module 125 can then provide the ranked competing entities for display to the first entity.

In some implementations, the competitor identification module 125 can be configured to identify a predetermined number of competitors based on their overlap rates. For example, the predetermined number of competitors may be 5. In some such implementations, the competitor identification module 125 can be configured to rank the competing entities according to their overlap rates and then select the competing entities having the top 5 highest overlap rates. The competitor identification module 125 may then provide the list of the selected competing entities for display to the first entity.

To better understand the functionality of the auction log analysis module 120 and the competitor identification module 125, an example analysis is described herein. Shown below is a sample implementation of an auction log.

```
  auction_id: 12345
  shown_impression: {
    auction_position  : 1
    campaign_id  : 111
    visible_domain  : ″exampletravelsite.com″
  }
  shown_impression: {
    auction_position  : 2
    campaign_id  : 222
    visible_domain  : ″exampletravelsite2.com″
    shown_ad_extensions: [ ONE_LINE_SELLER_RATING]
    }
  }
  shown_impression_set: {
    auction_position  : 3
    campaign_id  : 333
    visible_domain  : ″exampletravelsite3.com″
shown_ad_extensions: [SOCIAL_AGGREGATE_ANNOTATION,
ONE_LINE_SITELINKS]
    }
  }
  not_shown_impression: {
    auction_position: 4
    campaign_id  : 444
  }
  not_shown_impression: {
    auction_position: 5
    campaign_id  : 555
  }
```

As shown above, the auction log shown an entry corresponding to a particular auction, identified here as 12345. In some implementations, the auction can be an auction to serve one or more ads on a web page display search results. The auction identifies 5 competing bids for ads. Three of the ads received impressions, while two of the ads did not receive impressions. As indicated in the auction log entry, the advertisers are represented as campaign identifiers while the competitors are represented as visible domains. The campaign identifiers 111, 222 and 333 achieved auction positions 1, 2 and 3, respectively, while campaign identifiers 444 and 555 achieved auction positions 4 and 5, which did not receive impressions. The visible domain of the campaign identifier 111 is exampletravelsite.com, the visible domain of the campaign identifier 222 is exampletravelsite2.com and the visible domain of the campaign identifier 333 is exampletravelsite3.com. The ad corresponding to the campaign identifier 222 was shown with a seller rating content extension indicating a seller rating of the visible domain corresponding to the campaign identifier 222. The ad corresponding to the campaign identifier 333 was shown with two content extensions. The first content extension shown is a social aggregate annotation content extension indicating a number of approvals, for example, ‘+ls’ or ‘likes’ received by a social networking page associated with the visible domain. The second content extension is a sitelinks content extension identifying one or more sitelinks, which when clicked by a user, can direct the user to a particular webpage associated with the visible domain of the campaign identifier 333.

From the auction log data, the auction log analysis module 120 can analyze each entry of the auction log and increment a first number of auctions (denoted as A) in which a particular competitor achieved an impression with a given ad extension, while the advertiser also showed an impression. The auction log analysis module 120 can also analyze each entry of the auction log and increment a second number of auctions (denoted at B) in which the particular competitor achieved an impression with a given ad extension, while the advertiser was competing in the auction. In some implementations, the advertiser is considered to be competing in the auction as long as the advertiser places a bid, regardless of whether the ad for which the bid was placed receives an impression. The auction log analysis module 120 can then determine the overlap rate by determining the ratio of the first number (A) to the second number (B). In some implementations, the overlap rate (A/B) is determined for a specific competitor and specific content extension.

The example herein describes how the first number and the second number would be incremented for some advertiser, competitor and ad extension group for the auction log entry shown above.

As described above, in the auction log entry shown above, example campaigns 111, 222, and 333 showed an ad, while 444 and 555 competed but did not show an ad. Campaign 222 and 333 showed an ad with ad extensions:
ONE_LINE_SELLER_RATING for campaign 222,
SOCIAL_AGGREGATE_ANNOTATION and ONE_LINE_SITELINKS for campaign 333.

By way of example, the following counters with respect to campaign identifier 111 are incremented based on the log entry corresponding to auction ID 12345:
A(111, “exampletravelsite2.com”, ONE_LINE_SELLER_RATING)+=1
B(111, “exampletravelsite2.com”, ONE_LINE_SELLER_RATING)+=1
A(111, “exampletravelsite3.com”, SOCIAL_AGGREGATE_ANNOTATION)+=1
B(111, “exampletravelsite3.com”, SOCIAL_AGGREGATE_ANNOTATION)+=1
A(111, “exampletravelsite3.com”, ONE_LINE_SITELINKS)+=1
B(111, “exampletravelsite3.com”, ONE_LINE_SITELINKS)+=1

By way of the same example, the following counters with respect to campaign identifier 444 are incremented based on the log entry corresponding to auction ID 12345:
B(444, “exampletravelsite2.com”, ONE_LINE_SELLER_RATING)+=1
B(444, “exampletravelsite3.com”, SOCIAL_AGGREGATE_ANNOTATION)+=1
B(444, “exampletravelsite3.com”, ONE_LINE_SITELINKS)+=1

It should be noted that the following counters did not increment by 1 because the campaign 444 did not receive an impression.
A(444, “exampletravelsite2.com”, ONE_LINE_SELLER_RATING);
A(444, “exampletravelsite3.com”, SOCIAL_AGGREGATE_ANNOTATION); and
A(444, “exampletravelsite3.com”, ONE_LINE_SITELINKS).

In some implementations, the auction log analysis module 120 can be configured to first identify each auction log entry for which an analysis is to be performed. For example, the auction log analysis module 120 can be configured to perform an analysis using data corresponding to one day, one week, one month, or any other granularity that can be processed in a reasonable manner by the data processing system. Upon identifying the auction log entries, the auction log analysis module 120 can determine one or more of the different content extensions associated with ads that received impressions.

In some implementations, the auction log analysis module 120 can be configured to perform an analysis on a given type of content extension, for example, sitelinks content extensions. The auction log analysis module 120 can be configured to identify all of the auction log entries in which an ad including a sitelinks content extension was selected for display. For each of the identified auction log entries, the auction log analysis module 120 can be configured to create counters for each advertiser. In particular, the auction log analysis module can create both A and B counters for each advertiser that competed in the identified auction log entries. In particular, the auction log analysis module 120 can create both A and B counters for each advertiser, competitor and sitelinks content extension group.

In some implementations, the auction log analysis module 120 can be configured to increment the A and B counters upon inspecting each of the identified auction log entries in which an ad including a sitelinks content extension was selected for display. In some implementations, the auction log analysis module 120 can increment the counters as shown above with respect to the example auction log entry.

In some implementations, the competitor identification module 125 can be configured to determine an overlap rate for each advertiser, competitor and sitelinks content extension group. The competitor identification module 125 can further be configured to determine an overlap rate by determining the ratio of the counter A for a given advertiser, competitor and sitelinks content extension group to the counter B for the same advertiser, competitor and sitelinks content extension group. In some implementations, the competitor identification module 125 can determine the ranking of the competitors based on their overlap rates. The competitors having the higher overlap rates can be ranked higher than competitors having lower overlap rates.

In some implementations, the data processing system 110, via one or more of the auction log analysis module 120 and the competitor identification module 125 can be configured to identifying competitors using any given type of content extension in the manner described above. It should be appreciated that a first entity or advertiser may have different competitors for different types of content extensions.

In some implementations, the auction log analysis module 120 can be configured to determine an overlap rate for a second type of content extension for a given competing entity of the first entity. In some implementations, the auction log analysis module 120 can identify, for a competing entity of the first entity, a third number of auctions in which a content item having a second type of content extension (different from the first type of content extension) of the competing entity was selected for display and a third-party content item of the first entity also was selected for display. The auction log analysis module 120 can also determine, for the competing entity, a fourth number of auctions in which a content item having the second type of content extension of the competing entity was selected for display and the first entity competed in the auction, or stated differently, the first entity placed a bid. In some implementations, the competitor identification module 125 can then compute, for the competing entity, an overlap rate for the second type of content extension based on the ratio of the third number of auctions to the fourth number of auctions. This process of computing the third and fourth number of auctions can be repeated for each potential competing entity of the first entity for the second type of content extension. The competitor identification module 125 then ranks one or more of the competing entities based on their associated overlap rates for the second type of content extension.

In some implementations, the data processing system 110 can be configured to identify competitors of a first entity using one or more alternate processes. In some implementations, the auction log analysis module 120 can be configured to determine, for each identified competing entity, a first number of impressions achieved by the competing entity. This can correspond to a number of auctions in which the competing entity participates and wins. For reference purposes, the first number of impressions can be denoted as Aₙ.

In some implementations, the auction log analysis module 120 can be configured to determine, for the competing entity, a second number of impressions achieved by the competing entity in auctions where the first entity was competing. The number of impressions achieved by the competing entity can correspond to the number of auctions in which a content item of the competing entity was selected to receive an impression. In some implementations, the first entity competes in an auction by placing a bid for a content item to receive an impression. For reference purposes, the second number of impressions can be denoted as Bₙ.

In some implementations, the auction log analysis module 120 can be configured to determine a number of impressions received by the content-extension content items of the competing entity. A content-extension content item is a content item having one or more particular content extensions. For example, the content-extension content item can include content items having sitelinks or content items having a click to call feature. For reference purposes, the number of number of impressions content-extension content items of the competing entity achieved can be denoted as Sₙ.

In some implementations, the auction log analysis module 120 can identify a number of auctions in which the competing entity showed above the first entity. Stated in another way, the auction log analysis module can identify the number of auctions in which content items of both the competing entity and the first entity was selected for display and the content item of the competing entity had a higher rank than the content item of the first entity. A higher ranked content item typically corresponds to the higher-ranked content item being shown above a lower ranked content item. For reference purposes, the number of queries in which the competing entity showed above the first entity can be denoted as Cₙ.

In some implementations, the auction log analysis module 120 can identify a number of auctions in which the competing entity showed below the first entity. Stated in another way, the auction log analysis module can identify the number of auctions in which content items of both the competing entity and the first entity was selected for display and the content item of the competing entity had a lower rank than the content item of the first entity. A lower ranked content item typically corresponds to the lower-ranked content item being shown below a higher ranked content item. For reference purposes, the number of queries in which the competing entity showed below the first entity can be denoted as Dₙ.

In some implementations, the auction log analysis module 120 can determine the number of auctions in which both the first entity and the competing entity received impressions on content items. To determine this number, the auction log analysis module 120 can compute the sum of the number of queries in which the competing entity showed above the first entity (Cₙ) and the number of queries in which the competing entity showed below the first entity (Dₙ). For reference purposes, the number of auctions in which both the first entity and the competing entity received impressions on content items is denoted as Cₙ+Dₙ.

In some implementations, the competitor identification module 125 can compute the overlap rate of the first entity and the competing entity by determining the ratio of the number of auctions in which both the first entity and the competing entity received impressions on content (Cₙ+Dₙ) to the first number of impressions achieved by the competing entity (Aₙ). For reference purposes, the overlap rate can be denoted as (Cₙ+Dₙ)/Aₙ and mathematically also corresponds to (Cₙ+Dₙ)/Aₙ.

In some implementations, the competitor identification module 125 can compute the content extension usage rate by determining the ratio of the number of impressions content-extension content items of the competing entity achieved (Sₙ) to the second number of impressions achieved by the competing entity in auctions where the first entity was competing (Bₙ). For reference purposes, the content extension usage rate can be denoted as Sₙ/Bₙ and mathematically also corresponds to Sₙ/Bₙ.

In some implementations, the competitor identification module 125 can compute the content extension usage overlap rate by determining the product of the overlap rate (Cₙ+Dₙ)/Aₙ and the content extension usage rate (Sₙ/Bₙ). In some implementations, the data processing system 110 can assume that the content extension usage rate (Sₙ/Bₙ) of an entity is independent of the first entity competing in an auction. For reference purposes, the content extension usage overlap rate can be denoted as O and mathematically corresponds to

O=(Cₙ+Dₙ)/Aₙ·(Sₙ/Bₙ).

The competitor identification module 125 then ranks one or more of the competing entities based on the calculated overlap rate for the first type of content extension.

In some implementations, the competitor identification module 125 can provide a predetermined number of competing entities in order of their rank for display. In some implementations, the data processing system can provide competing entities having an overlap rate greater than a predetermined threshold for display. For example, if the content extension usage overlap rate is greater than 5%.

In some implementations the data processing system can identify, from the identified auctions in which the first entity places a bid, one or more competing entities associated with a content placement campaign including at least one content item that includes a second type of content extension was selected for display in one or more of the identified plurality of auctions.

The data processing system 110 can also include one or more data stores, such as the database 140. The database can be included in the data processing system 110. In some implementations, the database may be located remote to the data processing system but accessible by the data processing system. The database can store a wide variety of content. For example, the database can store auction log data, including auction log data corresponding to the various types of content extensions. It should be appreciated that the data processing system 110 can include one or more additional modules to provide some or all of the features described herein as well as other additional features.

FIG. 2 is a diagram depicting content items including content extensions. As shown in FIG. 2, a content item 202 includes a geographic content extension 204. The geographic content extension allows for viewing a map of an address associated with a location of an entity associated with the content item. In some implementations, the geographic content extension can include a link, which when accessed, provides directions to the location of the entity.

A content item 212 includes a click to call content extension 214. The click to call content extension allows for establishing a call between a user and a phone number associated with the content item. The call may be established via a web application on a user's computing device. In some implementations, the call may be established via a user's phone.

A content item 222 includes a sitelinks content extension 224. The sitelinks extension 224 provides one or more links, which when accessed, direct the user to a web page to which the link is pointing. In this way, a user can access different web pages by clicking different links. Sitelinks give potential customers or campaign managers a shortcut to a product, promotion or any other page the content placement manager wants and to make the content item more prominent. Sitelinks can help viewers get to what the viewer is looking for in a single click.

A content item 232 includes a social aggregate annotator extension 234. The social aggregate annotator content extension 234 indicates a number of social networking users who have expressly approved the entity. As shown in the content item 232, the social aggregate annotator extension 234 indicates that the website www.example.com has 432,880 followers on Google+.

A content item 242 includes a ratings content extension 244. The ratings extension 244 indicates a rating of the entity associated with the content item (Tia's Ice Cream Store) and a number of seller reviews. In some implementations, the ratings extension 244 can show ratings associated with one or more third-party applications or websites. In addition, the ratings extension 244 may be configured to show snippets of sample reviews within the content item 242.

FIG. 3 is a screenshot of a user interface depicting a number of competing entities that use content extensions. The user interface 300 allows a content placement campaign manager to manage aspects of the content placement campaign. As shown in FIG. 3, the user interface 300 can provide information relating to one or more opportunities. In the user interface 300, the specific opportunity relates to the opportunity to improve the performance of the campaign by using a sitelinks content extension. In particular, the opportunity relates to adding sitelinks to the campaign “Fitness Equipment ExN-1” having a campaign identifier 302 having a value “151638866.” The user interface 300 can identify a number 312 of competing entities that are using sitelinks. The user interface 300 also provides a predicted improvement in the performance of the campaign and an increased cost that may be incurred when using sitelinks content extensions. The user interface 300 can also identify an identity 314 of the competing entities. The identity of the competing entities can be provided as visible domain names. In some implementations, this is similar to what a campaign manager would have been able to determine had the campaign manager manually performed a search, identified a content item having sitelinks and clicking on the content item or one of the links within the content item. A content item preview 320 is shown and includes four sitelinks within the content item. The campaign manager can create a content item having a sitelinks content extension via the user interface 300.

It should be understood that the data processing system does not share any bidding strategies of competing entities to the first entity. In particular, the data processing system does not share confidential budgetary information of a competing entity with a first entity and vice versa. For example, the data processing system does not share bid values placed by competing entities, or one or more criteria for identifying potential user devices to which to display content items, amongst others. To the extent that information associated with a plurality of competing entities is shared with the first entity, such data is based on aggregate data collected from a plurality of competing entities and the entity receiving the aggregate data is unable to attribute such data to any one particular competing entity of the plurality of competing entities.

It should also be understood that the content items having content extensions may participate in any auction-based content placement system in which the content provider providing the content items may place bids that are based on one or more of impressions, click throughs, actions, acquisitions, amongst others. For example, the bid values may be based on cost per thousand impressions (CPM), cost per click through, cost per call placed (in a content item including a click to call content extension), amongst others.

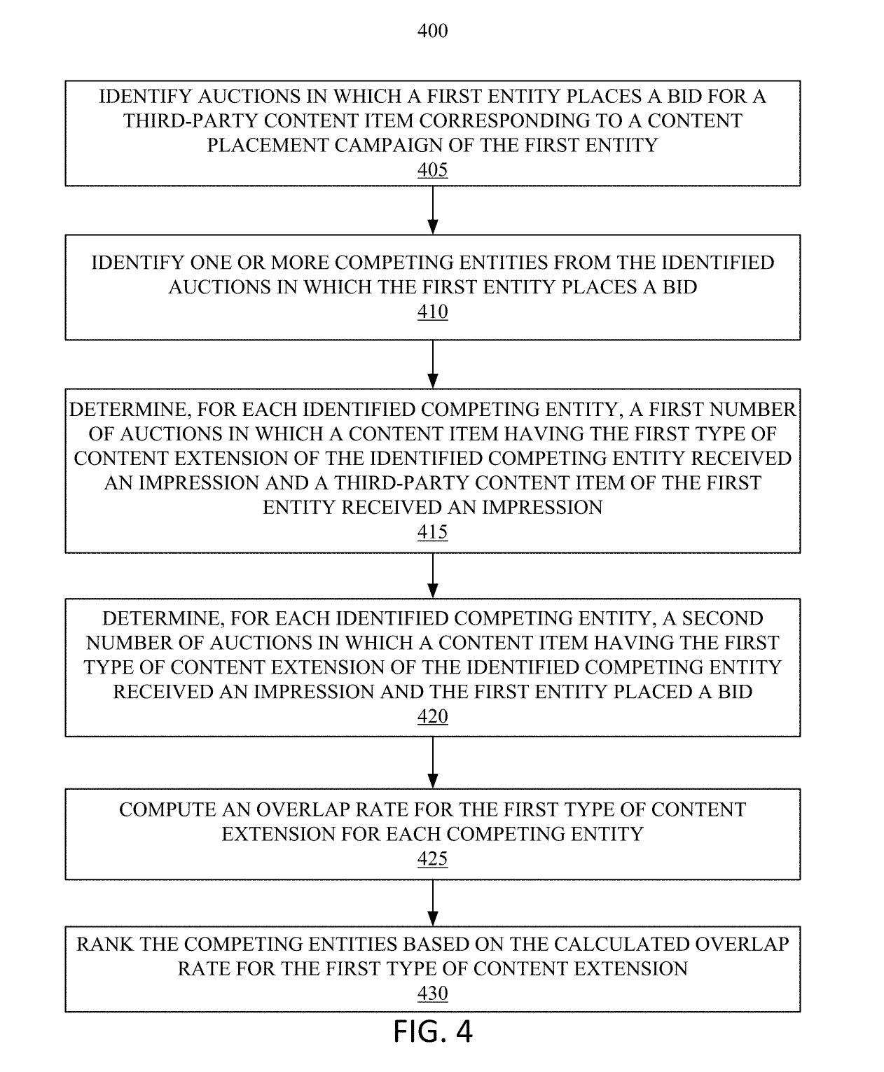

FIG. 4 is a flow diagram depicting one implementation of the steps taken to identify and rank competitors that use content extensions. In particular, FIG. 4 illustrates a flow diagram depicting a method 400 for identifying competitors using content items including content extensions. In brief overview, the data processing system can identify, from auction log data, a plurality of auctions in which a first entity places a bid for a third-party content item corresponding to a content placement campaign of the first entity (BLOCK 405). The data processing system can identify one or more competing entities from the identified auctions in which the first entity places a bid (BLOCK 410). The data processing system can determine, for each identified competing entity, a first number of auctions in which a content item having the first type of content extension of the identified competing entity was selected for display and a third-party content item of the first entity also was selected for display (BLOCK 415). The data processing system can also determine, for each identified competing entity, a second number of auctions in which a content item having the first type of content extension of the identified competing entity was selected for display and the first entity placed a bid (BLOCK 420). The data processing system can then compute, for each competing entity, an overlap rate for the first type of content extension based on the ratio of the first number associated with a particular competing entity to the second number associated with the particular competing entity (BLOCK 425). The data processing system can then rank one or more of the competing entities based on the calculated overlap rate for the first type of content extension (BLOCK 430).

In further detail, the data processing system can identify, from auction log data, a plurality of auctions in which a first entity places a bid for a third-party content item corresponding to a content placement campaign of the first entity (BLOCK 405). The auction log data can include a plurality of entries, each of which may correspond to a particular auction. The auction log data can include an auction identifier and a corresponding data set for each competing bid of the auction. Each data set can include an indication of whether a content item for which a bid was placed was selected for display, an auction position, a campaign identifier identifying a content placement campaign with which the content item was associated and a visible domain identifying a domain name.

The data processing system can identify one or more competing entities from the identified auctions in which the first entity places a bid (BLOCK 410). Each of the competing entities is associated with a content placement campaign that includes at least one content item having a first type of content extension that was selected for display in one or more of the identified plurality of auctions. In some implementations, the data processing system 110 can identify a website domain associated with the competing entities.

The data processing system can determine, for each identified competing entity, a first number of auctions in which a content item having the first type of content extension of the identified competing entity was selected for display and a third-party content item of the first entity also was selected for display (BLOCK 415). Examples of a first type of content extension include one of a click to call extension, a sitelinks extension, a rating extension, a geographical extension or a social aggregate annotation extension.

A competitor having a high first number indicates that the competitor is competing in auctions in which the first entity also competes. However, even though the competitor may be competing with the first entity in the auctions in which the first entity also competes, the competitor may also be competing in a lot of other auctions. In some implementations, the data processing system can maintain a first counter corresponding to the first number. The counter can be specific to a particular first entity, competitor and content extension type.

The data processing system can also determine, for each identified competing entity, a second number of auctions in which a content item having the first type of content extension of the identified competing entity was selected for display and the first entity placed a bid (BLOCK 420). In some implementations, the data processing system can maintain a second counter corresponding to the second number. The second counter can be specific to a particular first entity, competitor and content extension type. A competitor having a high second number indicates that the competitor is competing and bidding high in auctions that are not as relevant to the first entity. Conversely, a competitor having a low second number indicates that the competitor is also not competing or at least not bidding high in auctions that are not as relevant to the first entity. This is based on an assumption that the first entity is likely to bid high and receive impressions for content items in auctions that are important to the first entity.

The data processing system can then compute, for each competing entity, an overlap rate for the first type of content extension based on the ratio of the first number associated with a particular competing entity to the second number associated with the particular competing entity (BLOCK 425). In this way, the data processing system can compute an overlap rate for a type of content extension that is specific to the first entity and a particular competing entity. A high overlap rate can indicate that the first entity and particular competing entities are competitors.

The data processing system can then rank one or more of the competing entities based on the calculated overlap rate for the first type of content extension (BLOCK 430). In some implementations, the data processing system can provide a predetermined number of competing entities in order of their rank for display. In some implementations, one or more competing entities that have an overlap rate greater than a predetermined threshold.

According to another aspect, a data processing system identifies from auction log data, a plurality of auctions in which a first entity places a bid for a third-party content item corresponding to a content placement campaign of the first entity. The data processing system identifies one or more competing entities from the identified auctions in which the first entity places a bid. Each of the competing entities is associated with a content placement campaign that includes at least one content item having a first type of content extension that was selected for display in one or more of the identified plurality of auctions.

The data processing system can identify an advertiser impression count, which is a number of impressions received by content items of the advertiser. The data processing system can also identify a competitor impression count, which is a number of impressions received by content items of a competitor in auctions in which the advertiser was competing.

The data processing system can determine a competitor ad extension impression count, which is a number of impressions received by content items of a competitor having a particular ad extension. For example, the data processing system can determine a competitor sitelinked impression count, which is the number of sitelinked impressions achieved by the competitor in queries for which the advertiser was competing.

The data processing system can identify a competitor position rank count, which is a number of auctions in which a content item of the competitor showed above a content item of the advertiser. Stated in another way, the data processing system can identify a number of auctions in which a position rank of a content item of the competitor was higher than a corresponding position rank of the content item of the advertiser.

The data processing system can identify an advertiser position rank count, which is a number of auction in which a content item of the advertiser showed above a content item of the competitor. Stated in another way, the data processing system can identify a number of auctions in which a position rank of a content item of the advertiser was higher than a corresponding position rank of the content item of the competitor.

The data processing system can also identify a total impression count, which is a total number of auctions in which content items of both the advertiser and competitor received impressions. The total impression count can correspond to the sum of the competitor position rank count and the advertiser position rank count.

The overlap rate between the competitor and the advertiser is a ratio of the total impression count to the advertiser impression count. The ad extension rate is a ratio of the competitor ad extension impression count, which is the number of impressions received by content items of a competitor having a particular ad extension to the competitor impression count, which is the number of impressions received by content items of a competitor in auctions in which the advertiser was competing.

The data processing system can determine the ad extension overlap rate as the product of the overlap rate and the ad extension rate. The data processing system can determine the ad extension overlap rate for each competitor of the advertiser. The ad extension overlap rate can be specific to a particular ad extension, for example, sitelinks, click to call, amongst others.

The data processing system can then arrange a list of competitors and their corresponding ad extension overlap rate relative to the advertiser. The data processing system can rank the list of competitors based on the ad extension overlap rate. The data processing system can then provide, for display, one or more of the competitors on the list. In some implementations, the data processing system can provide, for display, competitors that have an ad extension overlap rate that exceeds a predetermined threshold, for example, 5%. In some implementations, the data processing system can rank the competitors according to their ad extension overlap rates and provide, for display, a predetermined number of competitors, for example, the top 5 competitors of the advertiser based on their ad extension overlap rate.

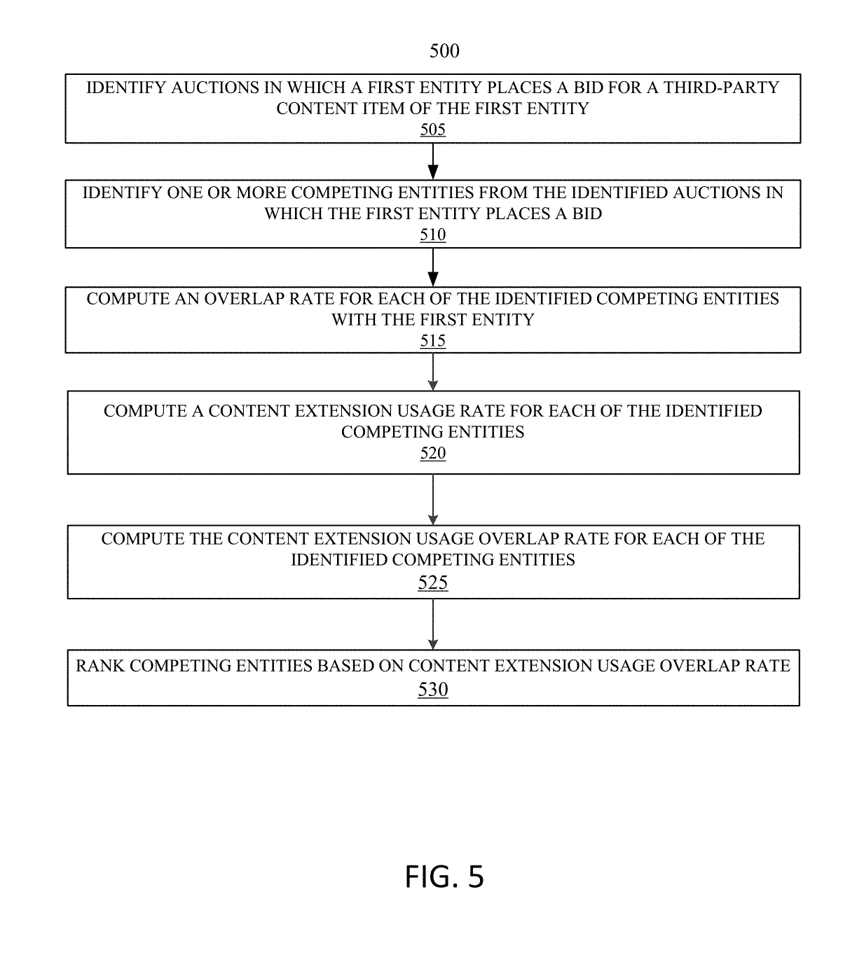

FIG. 5 is a flow diagram depicting one implementation of the steps taken to identify and rank competitors that use content extensions. In particular, FIG. 5 illustrates a flow diagram depicting a method 500 for identifying competitors using content items including content extensions. In brief overview, the data processing system can identify, from auction log data, a plurality of auctions in which a first entity places a bid for a third-party content item corresponding to a content placement campaign of the first entity (BLOCK 505). The data processing system can identify one or more competing entities from the identified auctions in which the first entity places a bid (BLOCK 510). The data processing system can compute, for each identified competing entity, an overlap rate representing how often a competitors content item was selected for display while the first entity's content item also was selected for display (BLOCK 515). The data processing system can compute, for each of the identified competing entities, a content extension usage rate representing how often a competitor displayed a content item having a content extension when displaying a content item (BLOCK 520). The data processing system can compute the content extension usage overlap rate for each of the identified competing entities (BLOCK 525). The data processing system can then rank the competing entities based on their computed content extension usage overlap rates (BLOCK 530).

In further detail, the data processing system can identify, from auction log data, a plurality of auctions in which a first entity places a bid for a third-party content item corresponding to a content placement campaign of the first entity (BLOCK 505). The auction log data can include a plurality of entries, each of which may correspond to a particular auction. The auction log data can include an auction identifier and a corresponding data set for each competing bid of the auction. Each data set can include an indication of whether a content item for which a bid was placed was selected for display, an auction position, which in some implementations, corresponds to a rank of the content item relative to other content items, a campaign identifier identifying a content placement campaign with which the content item was associated, an entity visible domain identifying a domain name associated with the first entity and one or more competitor visible domains identifying domain names associated with one or more competing entities that also participated in the auction. In addition, the auction log data set can also identify a content position of each of the content items for which the competing entities placed bids.

The data processing system can identify one or more competing entities from the identified auctions in which the first entity places a bid (BLOCK 510). Each of the competing entities is associated with a content placement campaign that includes at least one content item having a first type of content extension that was selected for display in one or more of the identified plurality of auctions. In some implementations, the data processing system 110 can identify a website domain associated with the competing entities.

The data processing system can compute, for each identified competing entity, an overlap rate representing how often a competitors content item was selected for display while the first entity's content item also was selected for display (BLOCK 515). In some implementations, to compute the overlap rate, the data processing system can determine, for each identified competing entity, a first number of impressions received by one or more content items of the competing entity. This can correspond to a number of auctions in which the competing entity participates in an auction to display a content item and the content item is selected for display. For reference purposes, the first number of impressions can be denoted as Aₙ. In some implementations, the data processing system can identify a number of auctions in which both a content item of the competing entity and a content item of the first entity receive impressions. In some implementations, the data processing system can determine this number by adding the number of auctions in which a content item of the competing entity showed above a content item of the first entity (referenced herein as Cₙ) and the number of auctions in which a content item of the competing entity showed below a content item of the first entity of a particular auction (referenced herein as Dₙ) In some implementations, the overlap rate can be computed by determining the ratio of the number of auctions in which both the first entity and the competing entity received impressions on content (Cₙ+Dₙ) to the first number of impressions achieved by the competing entity (Aₙ). For reference purposes, the overlap rate can be denoted as (Cₙ+Dₙ)/Aₙ and mathematically also corresponds to (Cₙ+Dₙ)/Aₙ.

The data processing system can compute, for each of the identified competing entities, a content extension usage rate representing how often a competitor displayed a content item having a content extension when displaying a content item (BLOCK 520). In some implementations, the data processing system can compute the content extension usage rate by determining a ratio of the number of impressions received by content-extension content items of the competing entity (Sₙ) to the number of impressions received by the competing entity in auctions where the first entity was competing (Bₙ). The data processing system can determine the number of impressions received by content-extension content items of the competing entity (Sₙ) and the number of impressions received by the competing entity in auctions where the first entity was competing (Bₙ) from auction log data.

The data processing system can compute the content extension usage overlap rate for each of the identified competing entities (BLOCK 525). In some implementations, the data processing system can compute the content extension usage overlap rate by determining the product of the overlap rate (Cₙ+Dₙ)/Aₙ and the content extension usage rate (Sₙ/Bₙ). In some implementations, the data processing system can assume that the content extension usage rate (Sₙ/Bₙ) of an entity is independent of the first entity competing in an auction. For reference purposes, the content extension usage overlap rate can be denoted as O and mathematically corresponds to

O=(Cₙ+Dₙ)/Aₙ·(Sₙ/Bₙ).

The data processing system can then rank the competing entities based on their computed content extension usage overlap rates (BLOCK 530). It should be appreciated that the data processing system can calculate the content extension usage overlap rate (O) for each potential competing entity corresponding to a particular type of content extension. The data processing system can sort the competing entities according to their content extension usage overlap rates and identify the top ten competing entities based on their content extension usage overlap rates.

The data processing system can provide a predetermined number of competing entities in order of their rank for display. In some implementations, the data processing system can provide competing entities having a content extension usage overlap rate greater than a predetermined threshold for display. For example, the data processing system can display all competing entities having a content extension usage overlap rate that is greater than 5%.

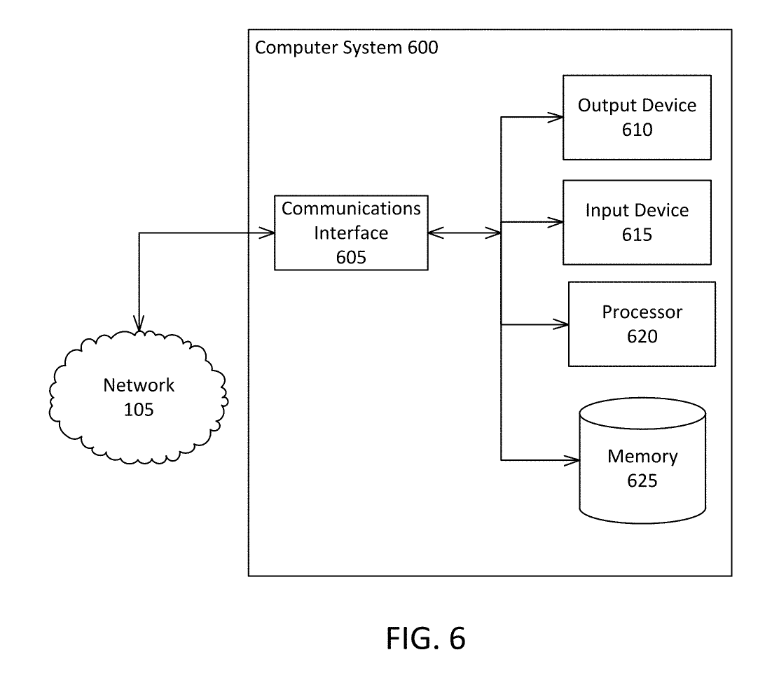

FIG. 6 shows the general architecture of an illustrative computer system 600 that may be employed to implement any of the computer systems discussed herein (including the system 100 and its components such as the auction log analysis module 120 and the competitor identification module 125) in accordance with some implementations. The computer system 600 can be used to provide information via the network 105 for display. The computer system 600 of FIG. 6 comprises one or more processors 620 communicatively coupled to memory 625, one or more communications interfaces 605, and one or more output devices 610 (e.g., one or more display units) and one or more input devices 615. The processors 620 can be included in the data processing system 110 or the other components of the system 100 such as the auction log analysis module 120 and the competitor identification module 125.

In the computer system 600 of FIG. 6, the memory 625 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the data processing system 110 can include the memory 625 to store information related to one or more text-based content items, image-based content items, one or more images to be used to create image-based content items based on the text-based content items, and one or more statistics associated with the images, text-based content items and image-based content items. The memory 625 can include the database 140. The processor(s) 620 shown in FIG. 6 may be used to execute instructions stored in the memory 625 and, in so doing, also may read from or write to the memory various information processed and or generated pursuant to execution of the instructions.

The processor 620 of the computer system 600 shown in FIG. 6 also may be communicatively coupled to or control the communications interface(s) 605 to transmit or receive various information pursuant to execution of instructions. For example, the communications interface(s) 605 may be coupled to a wired or wireless network, bus, or other communication means and may therefore allow the computer system 600 to transmit information to or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 600. Examples of communications interfaces 605 include user interfaces (e.g., web pages), through which the user can communicate with the data processing system 110.

The output devices 610 of the computer system 600 shown in FIG. 6 may be provided, for example, to allow various information to be viewed or otherwise perceived in connection with execution of the instructions. The input device(s) 615 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The terms “data processing apparatus”, “data processing system”, “user device” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The auction log analysis module 120 and the competitor identification module 125 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 600 or system 100 can include clients and servers. For example, the data processing system 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the auction log analysis module 120 and the competitor identification module 125 can be part of the data processing system 110, a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to an advertising program, the systems and methods described herein can be applied to any program in any vertical in which image-based content can be created from text-based content. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for identifying competitors using content extensions, comprising:
receiving, at a data processing system from a computing device, a request for a list of competitors of an online content provider;
identifying, by the data processing system, a plurality of content placement events in which the online content provider participated;
identifying, from the identified content placement events in which the online content provider participated, a plurality of competing content providers each of which respectively participated in at least one respective content placement event of the plurality of content placement events, each of the competing content providers' participation being associated with a respective content item selected for display in one of the identified content placement events, each content item having a first type of content extension;
for each of the identified competing content providers:
identifying a sub-set of content placement events of the plurality of content placement events in which the competing content provider participated, and in which the content item associated with the competing content provider was selected for display;
determining, for each content placement event of the sub-set of content placement events, whether a content item of the online content provider was also selected for display;
incrementing a numerator counter for each positive determination;
calculating a ratio of a count of the numerator counter to a total number of content placement events of the subset of content placement events; and
computing an overlap rate for the identified competing content provider using the ratio;
generating a ranking, specific to the first type of content extension, of one or more of the competing content providers based on their respective overlap rate; and
providing, for display at the computing device in response to the request, a list of a top one or more of the competing content providers, each competing content provider of the list having an overlap rate greater than a predetermined threshold.

2. The method of claim 1, wherein the first type of content extension includes one of a click to call extension, a sitelinks extension, a rating extension, a geographical extension or a social aggregate annotation extension.

3. The method of claim 1, wherein identifying the plurality of competing content providers includes identifying a website domain associated with the competing content providers.

4. The method of claim 1, wherein the list comprises a predetermined number of competing entities in order of their rank.

5. (canceled)

6. The method of claim 1, further comprising:
identifying, from the identified content placement events in which the online content provider participated, a second plurality of competing content providers each of which respectively participated in at least one respective content placement event of the plurality of content placement events, each of the competing content providers' participation being associated with a respective content item having selected for display in one of the identified content placement events, each content item having a second type of content extension;
for each of the identified competing content providers of the second plurality of competing content providers:
identifying a sub-set of content placement events of the plurality of content placement events in which the competing content provider participated, and in which the content item associated with the competing content provider was selected for display;
determining, for each content placement event of the sub-set of content placement events, whether a content item of the online content provider was also selected for display;
incrementing a numerator counter for each positive determination; and
calculating a ratio of a count of the numerator counter to a total number of content placement events of the subset of content placement events; and
computing an overlap rate for the identified competing content provider using the ratio; and
generating a ranking, specific to the second type of content extension, of one or more of the competing content providers based on their respective overlap rate.

7. A system for identifying competitors using content extensions, comprising:
a data processing system having an auction log analysis module and a competitor identification module, the data processing system further comprising:
a memory storing processor-executable instructions; and
a processor configured to execute the processor-executable instructors to:
receive, from a computing device, a request for a list of competitors of an online content provider;
identify a plurality of content placement events in which the online content provider participated
identify, from the identified content placement events in which the online content provider participated, a plurality of competing content providers each of which respectively participated in at least one respective content placement event of the plurality of content placement events, each of the competing content providers' participation being associated with a respective content item selected for display in one of the identified content placement events, each content item having a first type of content extension;
for each of the identified competing content providers:
identify a sub-set of content placement events of the plurality of content placement events in which the competing content provider participated, and in which the content item associated with the competing content provider was selected for display;
determine, for each content placement event of the sub-set of content placement events, whether a content item of the online content provider was also selected for display;
increment a numerator counter for each positive determination; and
calculate a ratio of a count of the numerator counter to a total number of content placement events of the subset of content placement events; and
compute an overlap rate for the identified competing content provider using the ratio;
generate a ranking, specific to the first type of content extension, of one or more of the competing content providers based on their respective overlap rate; and
provide, for display at the computing device in response to the request, a list of a top one or more of the competing content providers, each competing content provider of the list having an overlap rate greater than a predetermined threshold.

8. The system of claim 7, wherein the first type of content extension includes one of a click to call extension, a sitelinks extension, a rating extension, a geographical extension or a social aggregate annotation extension.

9. The system of claim 7, wherein identifying the plurality of competing content providers includes identifying a website domain associated with the competing content providers.

10. The system of claim 7, wherein the list comprises a predetermined number of competing content providers in order of their rank.

11.

12. The system of claim 7, wherein the processor is further configured to:
identify, from the identified content placement events in which the online content provider participated, a second plurality of competing content providers each of which respectively participated in at least one respective content placement event of the plurality of content placement events, each of the competing content providers' participation being associated with a respective content item having selected for display in one of the identified content placement events, each content item having a second type of content extension;
for each of the identified competing content providers of the second plurality of competing content providers:
identifying a sub-set of content placement events of the plurality of content placement events in which the competing content provider participated, and in which the content item associated with the competing content provider was selected for display;
determining, for each content placement event of the sub-set of content placement events, whether a content item of the online content provider was also selected for display;
incrementing a numerator counter for each positive determination; and
calculating a ratio of a count of the numerator counter to a total number of content placement events of the subset of content placement events; and
compute an overlap rate for the identified competing content provider using the ratio; and
generate a ranking, specific to the second type of content extension, of one or more of the competing content providers based on their respective overlap rate.

13-20. (canceled)

21. The method of claim 1 further comprising:
computing, for each of the identified competing entities, a content extension usage rate representing how often a competing content provider's content item having a content extension was displayed when displaying a content item;
computing a content extension usage overlap rate for each of the identified competing entities based on the computed overlap rate and content extension usage rate corresponding to the particular competing content provider for which the content extension usage overlap rate is computed; and
ranking the competing content providers based on their computed content extension usage overlap rates.

22. The method of claim 21, further comprising providing, for display, a list of the competing content providers having a content extension usage overlap rate greater than a predetermined threshold.

23. The method of claim 21, further comprising:
determining, by the data processing system, for each of the identified competing content providers, a first number of times a content item of the competing content provider was selected for display;
determining, for each of the identified competing content providers, a second number of times a content item of the competing content providers was selected for display in content placement events in which a content item of the online content provider was also selected for display; and wherein
computing, for each identified competing content provider, an overlap rate comprises determining a ratio of the second number of times a content item of the competing content provider was selected for display in auctions in which a content item of the online content provider was also were selected for display to the first number of times a content item of the competing content provider was selected for display.

24. The method of claim 21, wherein determining the second number of times includes: identifying a number of content placement events in which the competing content provider showed above the online content provider; identifying a number of content placement events in which the competing content provider showed below the online content provider; and
adding the number of content placement events in which the competing content provider showed above the online content provider and the number of content placement events in which the competing content provider showed below the online content provider.

25. The method of claim 21, wherein computing the content extension usage rate of a competing content provider includes determining a ratio of a total number of times content-extension content items of the competing content provider were selected for display to a number of times content-extension content items of the competing content provider were selected for display when the online content provider was competing, wherein each of the content-extension content items including a content item having a particular type of content extension.

26. The method of claim 21, wherein computing a content extension usage overlap rate for each of the identified competing content providers entities includes computing a product of the computed overlap rate and the computed content extension usage rate corresponding to the particular competing content provider for which the content extension usage overlap rate is computed.
